(19) United States
(12) Patent Application Publication
(10) Pub. No.: US 2018/0147788 A1
(43) Pub. Date: May 31, 2018

(54) JOINING METHOD AND DEVICE FOR PERFORMING THE JOINING METHOD

(71) Applicant: NEWFREY LLC, New Britain, CT (US)

(72) Inventors: Sascha GRAMSCH-KEMPKES, Giessen (DE); Alexander HOFMAN, Giessen (DE); Matthias LINKE, Giessen (DE); Karl-Heinz BRIEL, Giessen (DE)

(21) Appl. No.: 15/824,078

(22) Filed: Nov. 28, 2017

(30) Foreign Application Priority Data
Nov. 30, 2016 (EP) 16201508.5

(51) Int. Cl. B29C 65/36; C09J 5/06; B29C 65/48; B29C 65/78; B29C 65/00; F16B 11/00; F16B 17/00

(52) U.S. Cl. CPC B29C 65/3668; C09J 5/06; B29C 65/4835; B29C 65/485; B29C 65/486; B29L 2031/3005; B29C 65/7814; B29C 66/0242; F16B 11/006; F16B 17/002; B29C 65/489

(57) ABSTRACT

A method for joining a fastener to a workpiece. The method comprising the following steps. Providing a fastening element including: a shaft-shaped anchor section which extends between a first end and a second end along an anchor axis; a flange formed on and extending radially to the first end of the anchor section, and the flange at least partially forms an application section, and; a joining material pre-applied to the application section and lying in an at least partially solid state, and wherein the joining material includes a first adhesive material and a second adhesive material. Providing a workpiece including a carrier surface. Arranging the fastening element on the carrier surface. Mixing the first and second adhesive materials by rotating the fastening element. And, joining the fastening element to the workpiece via the cross-linking reaction of the first and second adhesive materials.

### CROSS-REFERENCE TO RELATED APPLICATION

This application claims priority from European Patent Application No. 16201508.5, filed on Nov. 30, 2016, the disclosure of which is incorporated herein by reference.

### BACKGROUND OF THE INVENTION

The present invention relates to a joining method of a fastening element on a workpiece and a device for performing the joining method.

In the technical field of the joining of fastening elements to workpieces, welding metallic studs to metallic workpieces, for example, is known. This method, which is known as “stud welding”, is used in particular in the automobile industry to weld studs to body panels, wherein fastening clips made of plastic are subsequently fastened to the studs, onto which cables, lines (e.g. electrical lines and/or brake lines) etc. are fixed.

Due to the fact that less weldable or non-metallic composite materials such as plastics, fibre composite components, etc. are increasingly being used, for example in the body construction of motor vehicles, adhesive technology has become established as a joining method, in particular in body construction. Instead of welding the studs to workpieces, these studs are glued.

A joining device for fastening a fastening element to a joining material on a carrier surface of a workpiece is known from document DE 10 2004 012 786 A1. Here, the fastening element is formed with a shaft-shaped anchor section, a flange section and a joining material which is pre-applied to an application section of the flange section. Anchor section and flange section are made of an inductively heatable material. The heating of the joining material before the placing on the carrier surface of the workpiece is carried out inductively, by induction energy being introduced into the flange section of the fastening element via an inductive field shaper, so that anchor section and flange section and also, as a result of this, indirectly, the joining material which has been applied to them, are heated. After the application of the fastening element to the workpiece, the inductive energy supply is terminated and the adhesive solidifies to produce the adhesive bond.

For mass production, the length of time required to perform the joining method is of particular significance. Previous approaches to performing the bonding method often require a length of time of several minutes. This is significantly longer in comparison to the stud welding mentioned initially, so there is a need to reduce this time.

A method for joining a fastening element to a surface section of a component is known from document DE 10 2009 042 467 A1, wherein the fastening element has an adhesive surface, to which a thermally meltable and curable adhesive is applied, comprising the steps of first preheating the adhesive to a first temperature in order to melt it, heating the surface section to a second temperature and applying the adhesive surface to the surface section, wherein the adhesive, after the adhesive surface is applied to the surface section, is heated to a third temperature in order to cure the adhesive and thereby fasten the fastening element permanently to the component.

The various steps of this method can be cumbersome and there is a need to simplify such methods and to further reduce the length of time, at the same time having good joining results. Furthermore there is a need for a method for joining the fastening element, wherein the fastening element has good storage stability and avoids an undesired chemical cross-linking reaction of the joining material before the actual adhesive method.

In view of the above, the object of the invention is to specify an improved joining method, as well as an improved joining device, which preferably simplifies the known joining methods.

### SUMMARY OF THE INVENTION

The above object is solved by a joining method having the steps of:

providing a fastening element having:

a shaft-shaped anchor section, which extends between a first and a second end section along an anchor axis, and

a flange section running transversely to the anchor section, wherein the flange section is formed at the first end section of the anchor section, wherein the flange section at least partially forms an application section,

a joining material, wherein the joining material is pre-applied to the application section, wherein the joining material lies on the application section in an at least partially solid state, and wherein the joining material has two adhesive materials,

providing a workpiece, wherein the workpiece has a carrier surface,

arranging the fastening element on the carrier surface of the workpiece,

joining of the fastening element to the workpiece via the cross-linking of the joining material,

characterised in that the joining material is mixed, and that the mixing of the joining material is carried out by a rotation of the fastening element relative to the workpiece.

The mixing of the joining material by a rotation of the fastening element relative to the workpiece allows rapid mixing of the two adhesive materials, without loss and directly on the workpiece. No preparation process is necessary and the joining method is simple and fast to carry out. According to a further preferred embodiment, the fastening element is rotated around the anchor axis.

In a preferred embodiment, the fastening element is received in a holding device. The holding device is, for example, a fastening bracket or a loading pin.

In a preferred embodiment, the holding device positions the fastening element on the carrier surface of the workpiece. For example, the holding device positions the fastening element on the carrier surface of the workpiece so that the flange section of the fastening element is in contact with the carrier surface.

In a preferred embodiment, the rotation of the fastening element relative to the workpiece is guided by the holding device. For example, the same holding device can move the fastening element along a joining axis and around the same joining axis.

According to a further preferred embodiment, the joining material has a first adhesive material and a second other adhesive material before the joining. Before the joining, the first adhesive material covers the second adhesive material completely. Such a joining material allows better storage stability before the joining method.

In a preferred embodiment, the joining material is heated before the rotation, in order to melt the joining material.

In a preferred embodiment, the anchor section and the flange section form a joining component. The heating of the joining material includes the heating of the joining component and/or the workpiece. Thermal conduction from the joining component and/or from the workpiece to the joining material takes place.

In a preferred embodiment the joining material is heated above the melting points of the first and second adhesive material.

In a preferred embodiment, the carrier surface has contaminants, and the contaminants are distributed in the joining material during the rotation of the fastening element relative to the workpiece, so that the carrier surface is cleaned.

In a preferred embodiment, the joining material is further heated to a cross-linking temperature after the mixing, in order to carry out the cross-linking of the joining material.

In a preferred embodiment, a torque is also applied to the fastening element during the cross-linking until the fastening element reaches a standstill.

In a preferred embodiment, the rotation of the fastening element relative to the workpiece is stopped before the joining.

In a preferred embodiment, an application of torque is exerted on the fastening element after the joining, in order to check the bonding of the fastening element.

In a preferred embodiment, the application section has a suitable surface structure, such that the adhesive materials move maximally during the rotation of the fastening element.

Moreover, the above object is solved by a joining device for carrying out the joining method, having: a holding device for holding a fastening element, wherein the holding device is suitable to be rotated around a joining axis, and a control device for controlling a rotation of the holding device.

In a preferred embodiment, the joining device has a heating device which is suitable for heating the joining material before and/or after and/or during the rotation of the holding device.

It is understood that the features mentioned above and those which are to be explained below can be used not only in the respective combination indicated, but also in other combinations or alone, without departing from the scope of the present invention.

### BRIEF DESCRIPTION OF THE SEVERAL VIEWS OF THE DRAWINGS

Exemplary embodiments of the invention are illustrated in the drawings and are explained in more detail in the following description. In the drawings:

FIG. 1 shows a schematic view of a workpiece and a fastening element in a receptacle of a joining device;

FIG. 2 shows a schematic view of a joining device according to the invention, according to a first embodiment;

FIG. 3 shows a schematic view of a joining device according to the invention, according to a further embodiment;

FIG. 4a shows a schematic cross-section of a fastening element having an anchor section, a flange section and a pre-applied joining material according to a first embodiment;

FIG. 4b shows a schematic cross-section of a fastening element having an anchor section, a flange section and a pre-applied joining material according to a further embodiment;

FIGS. 5a to 5d show several schematic illustrations of a flange section;

FIG. 6 shows a graphic illustration of the temperature and rotation control of an inventive joining method, according to one embodiment;

FIG. 7 shows a graphic illustration of the temperature and rotation control of a joining method according to the invention, according to a further embodiment;

FIG. 8a shows a view of a fastening element according to the invention, having the joining material according to one embodiment;

FIG. 8b shows a view of a fastening element according to the invention, having the joining material according to an alternative embodiment.

### DETAILED DESCRIPTION OF THE PREFERRED EMBODIMENTS

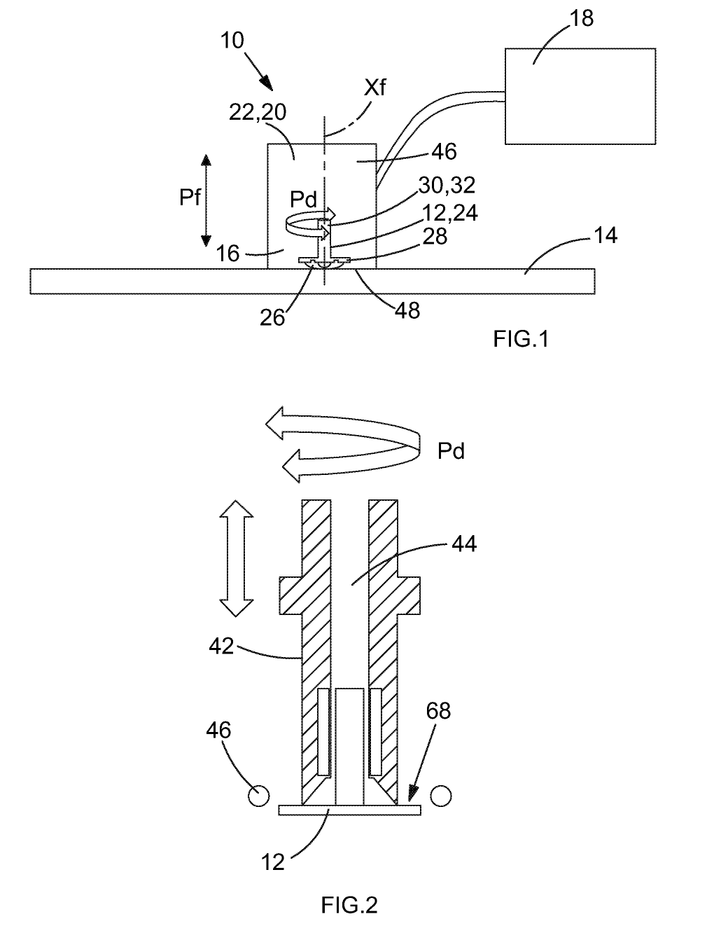

FIG. 1 illustrates a schematic view of a joining device 10, a fastening element 12 and a workpiece 14. The joining device 10 enables a joining method of a fastening element 12 to a workpiece 14 to be carried out.

The joining device 10 comprises a holding device 16 for holding the fastening element 12. The holding device 16 is designed to be rotated around a joining axis Xf. The holding device 16 is further designed to be moved along the joining axis Xf. Moreover, the joining device 10 has a control device 18, which is connected to the holding device 16 and controls a rotation of the holding device 16. The holding device 16 is designed to rotate the fastening element 12 around the joining axis Xf, as indicated by a double arrow Pd. The holding device 16 can also move the fastening element 12 along the joining axis Xf, as indicated by a second double arrow Pf. A motor 20 can rotate the holding device 16 and/or move along the joining axis. The motor 20 is, for example, a stepper motor, but other control/power supply systems can be provided in other embodiments. A torque sensor (or rotary encoder 22) can be coupled with the motor. The motor can be connected to the control device 18, and the control device controls the rotational movement of the motor 20.

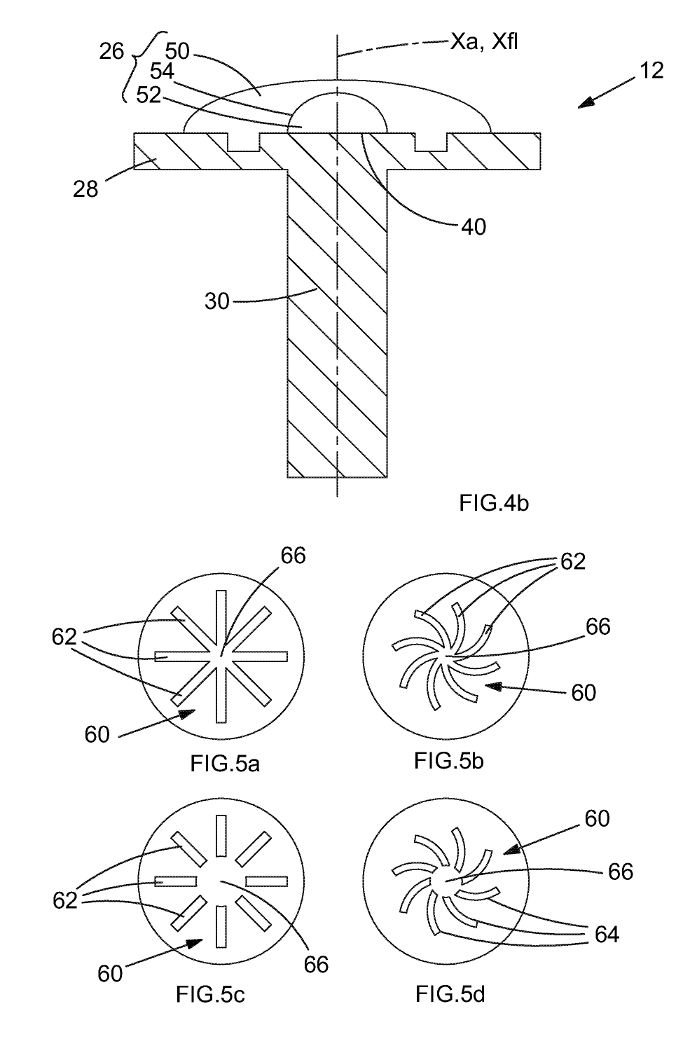

FIGS. 4a and 4b schematically illustrate two embodiments of the fastening element 12 in the longitudinal section. The fastening element 12 has a joining component 24 and a joining material 26 which is pre-applied to the joining component 24.

The joining component 24 has a flange section 28 and a shaft-shaped anchor section 30. The joining component 24 is a single unit.

In another embodiment, the joining component 24 can be in two parts. In this case, for example, the flange section 28 and the shaft-shaped anchor section 30 are two separate parts which are connected to each other.

The anchor section 30 has a main body 32, a first and a second end section 34, 36. The main body 32 extends along an anchor axis Xa between the first end section 34 and the second end section 36. The main body 32 of the anchor section 30 can assume the respectively desired shaft shape. As shown in FIG. 1, the main body 32 can have a circular cross-section, substantially constant over its length. In other embodiments, the anchor section 30 could also have a rectangular, triangular etc. cross-section. Likewise in other embodiments the main body 32 could be not constant over its length.

The second end section 36 of the anchor section is preferably round, but other forms of end sections could be provided. For example, the second end section 36 can be provided with a cut edge.

The anchor section 30 is preferably made from steel. Other metals such as, for example, aluminium or other materials can likewise be used.

The flange section 28 extends from the first end section 34. The flange section 28 is, for example, circular and aligned concentrically to a flange axis Xfl.

The joining component 24 has a joining surface 38. This joining surface 38 is preferably made from a metal material. The joining surface 38 is, for example, provided on the flange section 28. The joining surface 38 has an application section 40. The application section 40 is designed to receive a joining material 26.

The application section 40 is covered with the joining material. The joining material 26 is, for example, an adhesive material, which is applied to the application section 40 (or on the joining surface 38). The joining material 26 can be a droplet of glue, but other shapes can also be provided.

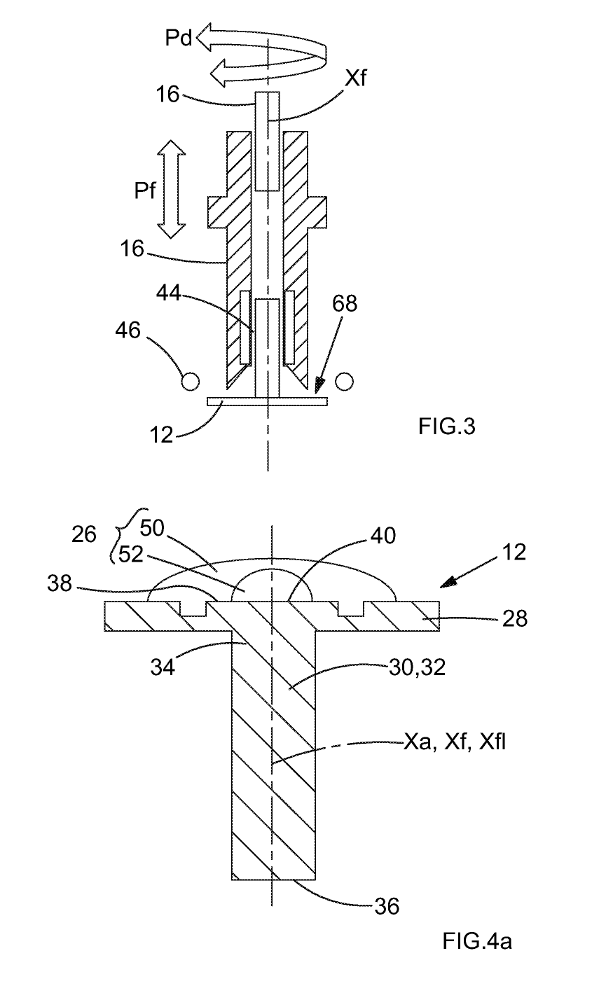

As shown in FIGS. 2 and 3, the fastening element 12 is accommodated by the holding device 16. In particular, the anchor section 30 of the fastening element 12 is accommodated by the holding device 16.

The holding device 16 can have a fastening bracket 42, as already shown in FIG. 2. The fastening bracket 42 is rotatably mounted in a housing of the joining device 10. The fastening bracket 42 has an opening 44 for accommodating the anchor section 30 of the fastening element 12. The connection of the fastening element 12 (or the anchor section 30) to the fastening bracket 42 can be carried out by positive locking. For example, the opening 44 can have a polyhedron receptacle, and the anchor section 30 is secured in this receptacle. The connection of the fastening element 12 (or the anchor section) with the fastening bracket 42 can also be carried out frictionally.

In a further embodiment, the holding device can have a loading pin (see FIG. 3). The loading pin is rotatable around the joining axis Xf.

The joining devices 10 illustrated in FIGS. 2 and 3 also have a heating device 46. The heating device 46 has, for example, an induction coil, in order to carry out heating of the fastening element 12 via induction. For example, a magnetic field transducer can be provided around the fastening element or around the anchor section. In further embodiments, the heating of the fastening element 12 can be carried out via infrared, hot air, ultrasound or other heat sources.

The holding device 16 moves the fastening element 12 onto the workpiece 14. The workpiece 14 has, for example, a carrier surface 48 and the holding device 16 brings the fastening element 12 onto the carrier surface 48. In particular, the flange section 28 is applied to the carrier surface 48, so that the joining material 26 is in contact with the carrier surface 48.

The joining material 26 has, for example, a first and a second other adhesive material 50, 52, as shown in FIG. 4a and FIG. 4b. The second adhesive material 52 is applied to the application section and the first adhesive material 50 covers the second adhesive material 52. The second adhesive material 52 is enclosed between the application section 40 and the first adhesive material 50.

The second adhesive material 52 can, for example, be centred on the flange section 28. The second adhesive material 52 can have a droplet shape or a strand shape; other shapes are also possible. For example, the second adhesive material 52 can consist of several droplets, which are all covered by the first adhesive material 50. The droplets can be formed to be round or elongated. The second adhesive material 52 can also be applied to the application section in a special pattern such as a cross, U or L shape.

The second adhesive material 52 is, for example, an adhesive curing agent. The second adhesive material 52 can also be an accelerant. The second adhesive material 52 can be liquid, paste-like or solid. Generally, the second adhesive material 52 will effect the cross-linking of a first adhesive material (e.g. an epoxy resin) via polyaddition reaction or polymerisation reaction. The volume of the second adhesive material can depend on the geometry of the joining component and/or the application section.

The second adhesive material is, as already written, covered by the first adhesive material 50. The first adhesive material 50, which encloses the second adhesive material 52, is, for example, an adhesive resin. The first adhesive material 50 can be an epoxy resin. The epoxy resin has a solid aggregate state below the cross-linking temperature and can be melted under the application of heat.

The first adhesive material 50 is visible from the outside, while the second adhesive material 52 is not visible from the outside. The second adhesive material 52 forms the core of the joining material 26 before the joining method. The first adhesive material 50 is disposed outwardly.

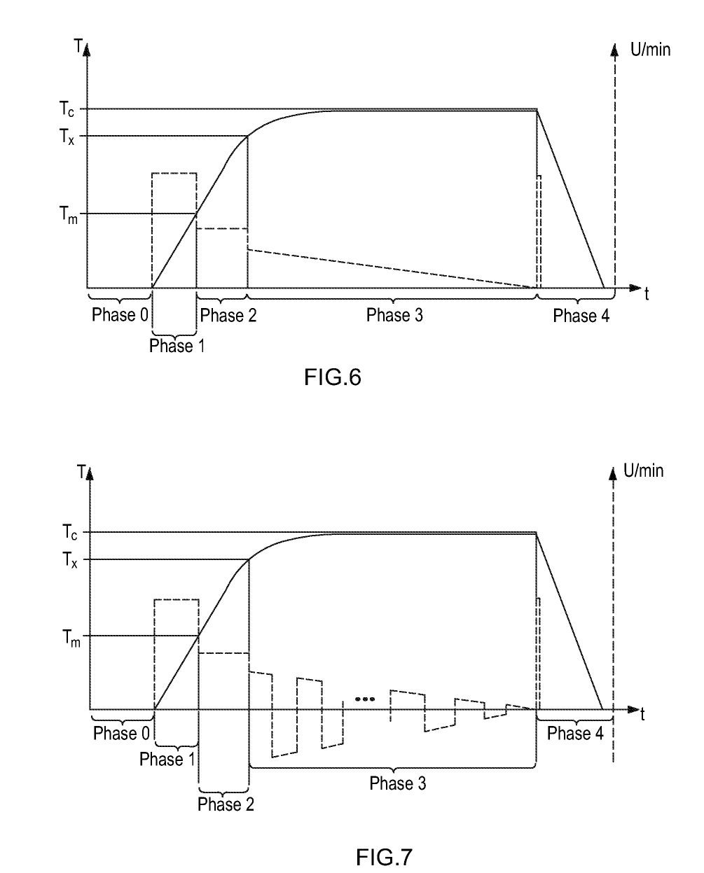

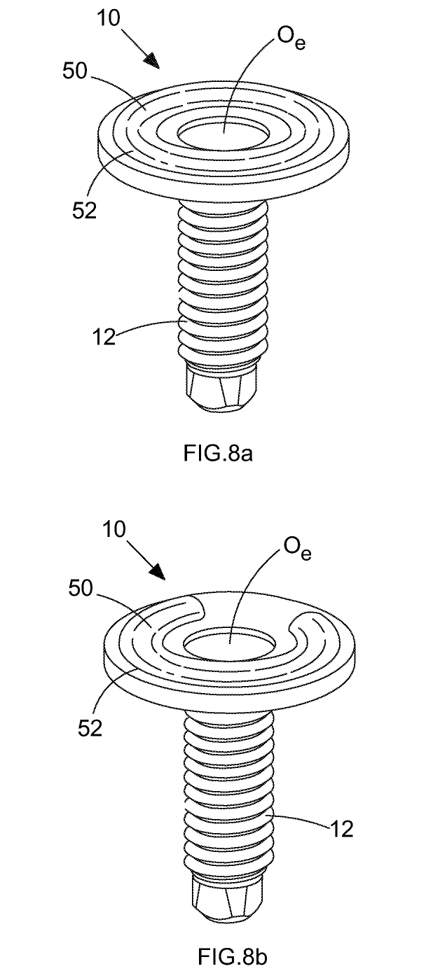

As illustrated in FIG. 8A and FIG. 8B, the joining material can form a circular (or annular) joining material strand. The circular joining material strand can be centred on the anchor axis Xa, or offset with respect to the anchor axis Xa. The circular joining material has an inner wall, which delimits a central opening Oe. The circular joining material strand can have a semi-circular cross-section. The joining material can form a continuous circular strand, as illustrated in FIG. 6A, or a strand which is interrupted once or several times. In FIG. 6B the joining material forms an arc, having two ends which are remote from each other. A receptacle is provided, for example, in the central opening Oe.

In FIGS. 8A and 8B the second adhesive material 52 (or the adhesive curing agent) is applied in the shape of a circular strand. The first adhesive material 50 is then applied, also in the shape of a circular strand, in order to cover the second adhesive material 52. Such an arrangement of the joining material allows a good mixing and a good distribution of the joining material. The adhesive strand is preferably remote from the outer surface of the flange section. The second adhesive material 52 is arranged in the centre of the first adhesive material 50. The second adhesive material 52 and/or the first adhesive material 50 have, for example, a semi-circular cross-section.

A dividing layer 54 can be provided between the first adhesive material 50 and the second adhesive material 52. The dividing layer 54 is applied to the second adhesive material 52 and covers the second adhesive material 52.

The dividing layer 54 forms a physical boundary between the first and second adhesive material 50, 52, in order to avoid an unwanted mixing of the two adhesive materials 50, 52.

After the application of the second adhesive material 52 to the application section 40, the dividing layer 54 is, for example, applied to the second adhesive material 52.

The dividing layer 54 can be applied to the second adhesive material 52 by a flame treatment with a silicon oxide (SiOx, e.g. Pyrosil®). The dividing layer 54 is then a silicone layer. A burner flame is preferably guided quickly over the second adhesive material 52. A silicone layer only a few nanometres thick but dense, for example, is deposited on the adhesive curing agent and enables a physical separation of the subsequently applied adhesive material. As an extremely short exposure to the coating flame is sufficient, only a moderate temperature rise is to be expected.

In another embodiment, a thin polymer layer could be deposited onto the second adhesive material by means of plasma flame or plasma polymerisation. This method is a method very similar to the Pyrosil flame method, with even lower thermal stress.

The dividing layer 54 can also be produced by powdering with a filler. A sol-gel process, PVD (physical vapour deposition), CVD (chemical vapour deposition), thermal spraying or cold gas spraying can likewise be provided for the dividing layer.

In general, any method for depositing a thin layer of polymer, metal or inorganic substances is suitable, provided the thermal stress is kept low.

The heating device 46 can heat the fastening element 12. For example, the heating device 46 will heat the flange section 28 and/or the anchor section, in order to indirectly heat the joining material. The heating device 46 could also warm the joining material 26 directly. The workpiece 14 can also be heated in order to indirectly heat the joining material 26.

In this case, however, the heating of the joining material is carried out by the heating device 46 heating the joining component 24, specifically via thermal conduction. Moreover, a heating of the joining material 26 takes place via thermal conduction inside the joining component 24. It is understood that the joining component 24 in this case is preferably formed so as to have good thermal conductivity, so for example is produced from a metallic material or from a plastic material with conductive (metallic) particles enclosed therein.

In the joining device 10 illustrated in FIG. 2 and FIG. 3, in particular the flange section 28 and/or the anchor section 30 can heat up and the joining material 26 can heat up via the heating of the flange section 28 and/or the anchor section 30. The heating of the joining material 26 can be carried out before or after the contact of the fastening element 12 with the workpiece 14.

The heating device 46 which heats the joining component 24 can be a first heating device 46, and a second heating device 56 can be provided in order to heat the workpiece 12 (as described below).

For example, in a first step the fastening element 12 is brought into contact with the carrier surface 48.

In a second step, the first heating device 46 (for example an inductor) heats the fastening element 12 (or the joining component 24). The fastening element 12 (or the joining component 24) is heated above the melting point Tm of the first and second adhesive material 50, 52. The joining material 26 melts.

The fastening element 12 is then caused to rotate by the holding device 16 under defined contact pressure on the carrying surface. The molten first and second adhesive material 50, 52 mix due to the rotation. The rotation of the fastening element 12 takes place around the joining axis Xf. The joining axis Xf and/or the anchor axis Xa and/or the flange axis Xfl can coincide.

The mixing of the joining material 26 is carried out by a combined movement from shearing on the application surface 40 and the squeezing of the joining material 26 during the application onto the workpiece 14 which is to be glued. The mixing (or intermixing) can be improved by a suitable surface structure or surface geometry of the application surface 40. Several different surface structures can be provided.

If a dividing layer 54 is provided, the dividing layer 54 is first dissolved by the heating of the joining material 14. Both adhesive materials (for example adhesive curing agent 50 and adhesive resin 52) will thus be in contact and mix.

A retentive surface structure having elevations which form material undercuts can, for example, be formed on the application surface. The production of material undercuts on the joining surface 38 is preferably described in DE102014118973. Microscopically small, protruding melt solidifications can, for example, be introduced as part of surface cleaning by means of high-energy focused radiation. Retentive structures can be generated either in a full-surface, partial or angular manner in relation to the relative movement.

Depressions in the flange section 28 (or in the application section 40) can also be used to improve the mixing. During the production of the flange section, depressions and grooves 58 can be pressed, in which can be arranged at an angle relative to the direction of rotation. Grooves and depressions 58 are only effective in partial or directed arrangement at an angle to the relative movement.

FIGS. 5a to 5d illustrate various surface structures 60 for retentive surface structure or depressions (or grooves). Such surfaces structures influence fluid movements. The distribution of possible contaminants is improved. The various surface structures 60 primarily serve for an increased shearing action to improve adhesive mixing when the fastening element is rotating. The movement of the molten joining material is improved.

The surface structures 60 illustrated in FIG. 5a and FIG. 5c have several segments 62, which together form a star. The segments 62 are spaced apart from one another at a certain angle around a centre point.

The surface structures illustrated in FIG. 5b and FIG. 5d have several curves 64, which together form a star. The curves 64 are spaced apart from one another at a certain angle around a centre point.

The midpoint 66 in FIG. 5c and in FIG. 5d is free from any retentive surface structure or depression. The structures illustrated (produced either as retentive surface structures or as depressions) influence the movement of media and allow an improved mixing of the joining material.

Furthermore, such surface structures can clamp the joining material 26 better onto the application section 40 of the fastening element 12 before the joining method.

In another embodiment, the first and second adhesive material 50, 52 can be heated and melt due to the rotation of the fastening element and the friction of the joining material 26 on the carrier surface 48.

Under further heat supply, the joining material 26 cross-links. The joining material 26 is further heated by the first heating device 46 and/or by the second heating device 56 and/or by a further heating device. The rotational movement is stopped during the cross-linking. In the present case, further heating of the joining material 26 is carried out by the first heating device 46.

In a further embodiment, the rotational movement of the holding device 16 can continue (for example with a lower torque). For example, the rotational movement will be carried out in an oscillating manner. The fastening element 12, and in particular the anchor section, can then slide into the receptacle of the holding element 16 as soon as the cross-linking is finished, as described further below. According to another embodiment, the motor 20 is blocked in its movement by the positive engagement between the fastening element 12 and the holding device 16.

After the cross-linking, the fastening element 12 is released from the holding device 16.

The mixing of the joining material 26 directly before the joining enables an extremely extended storage life of the fastening element 12 before the joining method.

The fastening element 12 can be stored and is transportable, for example from a place of production to a place in which the fastening element 12 is to be glued to the workpiece, without cooling or other similar considerations.

The workpiece 14 and the carrier surface 48 can have contaminants. For example, the contaminants can be adhesion-inhibiting oils, lubricants, varnishes, coatings, or other undesirable particles that remain on the carrier surface. Nowadays, such contaminants are removed from the workpiece 14 in a previous step, so as not to worsen the joining result. The rotation of the fastening element 12 allows this cleaning step to be carried out during the rotation, and thus time is saved.

During the rotation of the fastening element 12, the joining material 26 can be used as a cleaning medium for the carrier surface 48. In particular, the joining material 26 can be abrasive and the friction of the joining material 26 on the carrier surface 48 during the rotation of the fastening element 12 for the mixing of the joining material 26 can clean the carrier surface 48. The contaminants (adhesion-inhibiting oils, . . . ) are absorbed and distributed in the joining material 26, where they have no significant negative impact (e.g. on the adhesion of the fastening element). The rotation of the fastening element 12 is then used for mixing and for distribution of contaminants.

FIG. 6 and FIG. 7 illustrate two different embodiments of the joining method as a function of time. With the joining device 10, a joining operation can be carried out as follows.

The joining method illustrated in FIG. 6 has several steps.

In a first step (phase 0), the workpiece can be prepared. For example, a pre-heating of the workpiece takes place.

After the first step, the heating device 16 is switched on. The heating device 16 will heat the joining material 26 to the melting point of the first and/or second adhesive material 50, 52, directly or indirectly (in practice to a higher melting point of the first and second adhesive material 50, 52). A temperature sensor 68 can, for example, measure the temperature of the joining material and/or the flange section 28 and/or the carrier surface 48 and/or the workpiece 14. The temperature measurement can be carried out, for example, by infrared or by other known methods. The temperature sensor 68 can be a pyrometer. In another embodiment, the temperature could be calculated by controlling the heating device. A pyrometer can be provided to regulate the temperature.

The temperature of the joining material is increased. The temperature of the joining material will increase up to the cross-linking temperature of the joining material 26 (phase 1 and 2), corresponding to a heating ramp.

At the start of the heating ramp the fastening element 12 is brought into contact with the workpiece. A rotation of the fastening element is performed, in order to bring the fastening element into positive engagement with the bolt holder and/or to clean the carrier surface 48 (phase 1). The forming of the positive engagement and the cleaning are carried out with a first rotation speed r″1 of the fastening element.

Still during the heating ramp, after the placement of the fastening element and the production of the positive contact between fastening element and bolt holder, the mixing phase (phase 2) will take place. For example, the mixing phase is carried out when the temperature of the joining material has reached the melting point Tm of the first and second adhesive material 50, 52. The cleaning can be further carried out during phase 2. The mixing is carried out with a second rotation speed r″2 of the fastening element. The second rotation speed r″2 can be higher or lower than the first rotation speed r″1.

When the heating ramp reaches a certain temperature Tx, just below the cross-linking temperature, the torque on the fastening element and the rotation speed are reduced (beginning of phase 3). With increasing adhesive cross-linking, the torque will decrease proportionally to the method time, since the increasing viscosity of the joining material increasingly hinders the motor movement.

As soon as the temperature of the joining material 26 has reached the cross-linking temperature Tc, the temperature is maintained until complete cross-linking of the joining material (end of phase 3).

During the cross-linking phase (if the temperature is constant and equal to the cross-linking temperature), the torque will fall further until it reaches a standstill, as the rising viscosity of the joining material increasingly hinders the motor movement (end of phase 3-beginning of phase 4). At the same time as the fastening element reaches a standstill, the heating device will not heat the joining material anymore, and the temperature of the joining material decreases.

Instead of a torque application during the isothermal cross-linking in phase 3, a short rotational movement of the holding device (during phase 4) can also be applied after a defined timespan at the beginning of phase 4 in order to check the strength of the connection between fastening element 12 and workpiece 14. If the fastening element ceases to rotate, the fastening element has been properly glued to the workpiece.

In FIG. 7, the temperature curve of the joining material is similar to the one already described in FIG. 6. The torque application is also the same as phase 0, phase 1 and phase 2 which were already described in FIG. 6. After the mixing and cleaning phase, an alternative torque application (phase 3) is exerted, which rotates the fastening element around the joining axis Xf in one direction and then in the other direction. The rotational movement is carried out in an oscillating manner. The amplitude of the torque is reduced by the increasing viscosity of the joining material as cross-linking progresses and the consequently increasing movement impediment, until finally it reaches a standstill.

Instead of a torque application during the isothermal cross-linking in phase 3, a short rotational movement of the holding device (during phase 4) can also be applied after a defined timespan at the beginning of phase 4, in order to check the strength of the connection between fastening element 12 and workpiece 14. If the fastening element ceases to turn, the fastening element is properly glued to the workpiece.

Afterwards, the holding device 16 will release the fastening element which is now joined to the workpiece 14. A further fastening element 12 can then be received by the holding device 16, which is to be joined to a further workpiece 14.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A method for joining a fastener to a workpiece, the method comprising the steps of:
providing a fastening element including: a shaft-shaped anchor section which extends between a first end section and a second end section along an anchor axis; a flange section formed on and extending radially to the first end section of the anchor section, and the flange section at least partially forms an application section, and; a joining material pre-applied to the application section and lying on the application section in an at least partially solid state, and wherein the joining material includes a first adhesive material and a second adhesive material;
providing a workpiece, wherein the workpiece includes a carrier surface;
arranging the fastening element on the carrier surface of the workpiece;
mixing the first adhesive material and the second adhesive material by rotating the fastening element relative to the workpiece; and
joining the fastening element to the workpiece via the cross-linking reaction of the first adhesive material and the second adhesive material.

2. A method of joining according to claim 1, wherein the fastening element is rotated around the anchor axis.

3. A method of joining according to claim 1, and further comprising the steps of:
placing the fastening element in a holding device; and
moving the holding device and the fastening element to the carrier surface of the workpiece.

4. A method of joining according to claim 3, wherein the rotating of the fastening element relative to the workpiece is guided by the holding device.

5. A method of joining according to claim 1, where, in the step of providing the fastening element, the first adhesive material fully covers the second adhesive material.

6. A method of joining according to claim 1, and further comprising a step of heating and melting the joining material before the step including the rotating of the fastening element.

7. A method of joining according to claim 6, wherein the anchor section and the flange section form a joining component, and the heating of the joining material includes the heating of at least one of the joining component and the workpiece, and there is thermal conduction from at least one of the joining component and the workpiece into the joining material.

8. A method of joining according to claim 5, where, in the step of heating of the joining material, the joining material is heated above the melting points of the first and second adhesive materials.

9. A method of joining according to claim 1, wherein the carrier surface includes a contaminant, and wherein the contaminant is distributed in the joining material during the step of rotating the fastening element relative to the workpiece, so that the carrier surface is cleaned.

10. A method of joining according to claim 6, and further comprising a step of further heating the joining material to a cross-linking temperature after the step of mixing the first adhesive material and second adhesive material.

11. A method of joining according to claim 1, wherein a torque is applied to the fastening element during the cross-linking, until the fastening element reaches a standstill.

12. A method of joining according claim 1, wherein the rotating of the fastening element relative to the workpiece is stopped before the joining.

13. A joining device for carrying out a method of joining a fastening element, including a solid first adhesive material and a second adhesive material, to a workpiece, the joining device comprising:
a holding device for holding the fastening element, wherein the holding device is operable to be rotated around a joining axis, and
a control device operable for controlling a rotation of the holding device and the mixing of the first adhesive material with the second adhesive material.

14. A joining device according to claim 13, and further comprising a heating device operable for heating the first adhesive material and the second adhesive material to a melting temperature and a cross-linking temperature during at least one of before and after and during the rotation.
